(19) United States
(12) Patent Application Publication
(10) Pub. No.: US 2017/0362064 A1
(43) Pub. Date: Dec. 21, 2017

(54) Elevator Car and Elevator System

(71) Applicant: Otis Elevator Company, Farmington, CT (US)

(72) Inventor: Helmut Lothar Schroeder-Brumloop, Berlin (DE)

(21) Appl. No.: 15/621,680

(22) Filed: Jun. 13, 2017

(30) Foreign Application Priority Data
Jun. 15, 2016 (EP) 16174581.5

(51) Int. Cl. B66B 13/28; B66B 9/00; B66B 11/00; B66B 1/28; B66B 11/02

(52) U.S. Cl. CPC B66B 13/285; B66B 11/0005; B66B 1/28; B66B 9/00; B66B 11/02

(57) ABSTRACT

An elevator car (6) which is configured for traveling along a hoistway (4) extending between a plurality of landings (8a, 8b, 8c), comprises an apron (20) arranged below the elevator car (6). The apron (20) is movable between at least two positions including: a blocking position in which the apron (20) extends downward from a bottom (9) of the elevator car (6) blocking access to the hoistway (4) through an area below the elevator car (6); and an access position, in which the apron (20) allows access to the hoistway (4) through an area below the elevator car (6).

The invention is related to an elevator car and to an elevator system comprising an apron, in particular a movable apron. The invention is further related to a method of accessing the hoistway of an elevator system by moving an apron of the elevator system.

Due to safety requirements elevator cars are provided with aprons extending from the bottom of the elevator car. The aprons are configured for preventing persons from falling into the hoistway in situations in which the landing doors are opened although the elevator car is positioned not exactly at a landing, i.e. not at the same level of height as a landing. Such situation might occur in an emergency rescue operation when releasing passengers which are trapped in a blocked elevator car due to a malfunction of the elevator system, for example.

Access to the hoistway is required in some situations, e.g. service personnel needs to enter the hoistway, in particular a pit at the bottom of the hoistway, for repair and/or maintenance purposes. However, an apron blocks such access. Providing means for allowing access to the hoistway, if desired, usually requires space in the hoistway. However, available space in the hoistway is very limited.

Therefore, it would be beneficial to allow service personnel to enter the hoistway in a simple way, if desired, but still provide the necessary measures for preventing persons from falling into the hoistway.

According to an exemplary embodiment of the invention, an elevator car, which is configured for traveling along a hoistway extending between a plurality of landings, comprises an apron arranged at the bottom of the elevator car. The apron is movable between at least two positions including a blocking position in which the apron extends downward from the bottom of the elevator car blocking access to the hoistway via an area below the elevator car, and an access position, in which the apron allows access to the hoistway via the area below the elevator car.

Exemplary embodiments of the invention further include an elevator system comprising an elevator car with a movable apron according to an exemplary embodiment of the invention, and a method of accessing the hoistway of such an elevator system. The method includes the step of moving the apron from its blocking position into its access position.

Exemplary embodiments of the invention provide the required safety of preventing persons from falling into the hoistway when the apron is positioned in its blocking position. But they allow easy access to the hoistway when the apron is moved into its access position.

Service personnel may enter the hoistway without being blocked by the apron. As a result, maintenance and repair of the elevator system is considerably facilitated without reducing the safety of the elevator system.

Exemplary embodiments of the invention will be described in more detail with respect to the enclosed figures:

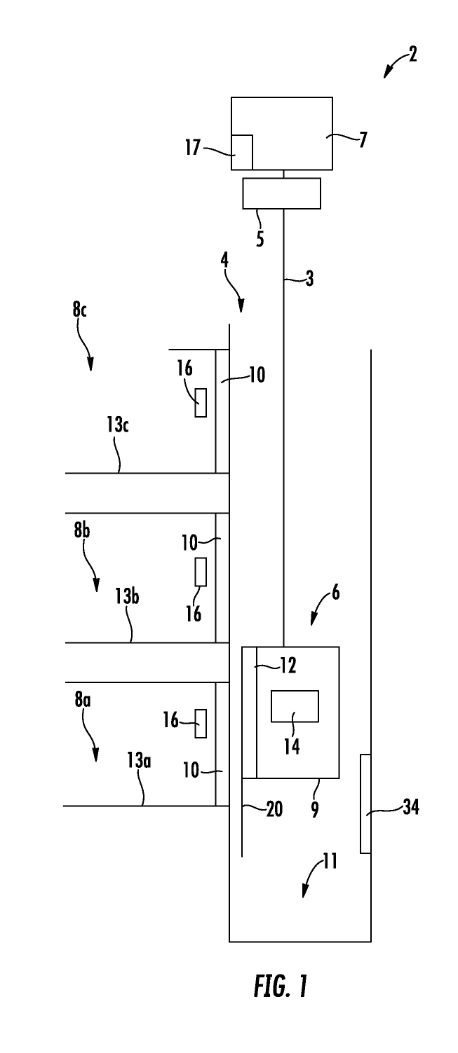

FIG. 1 depicts a schematic view of an elevator system according to an exemplary embodiment of the invention.

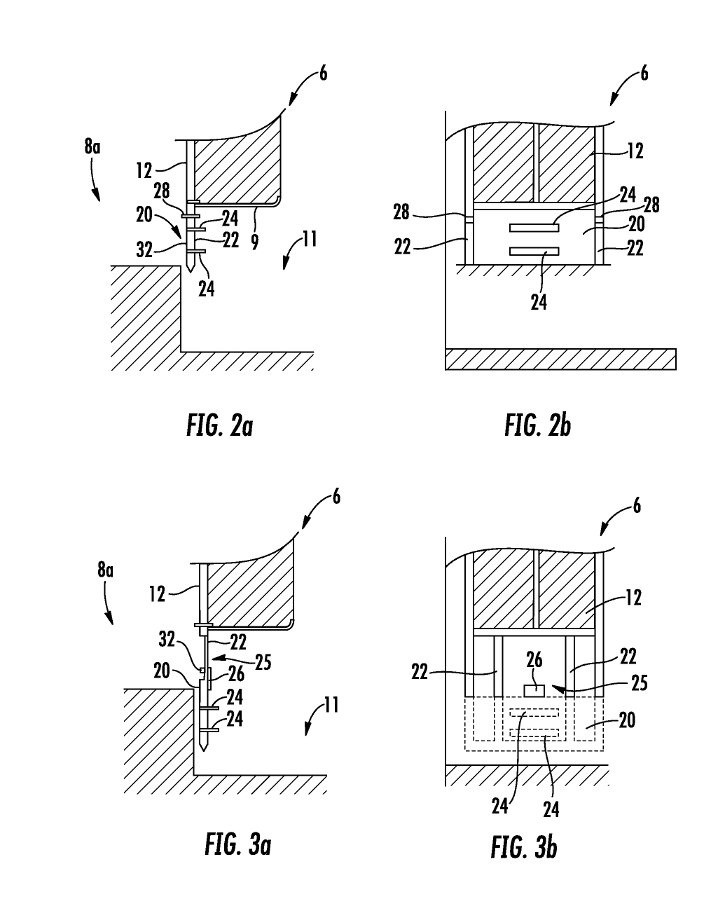

FIGS. 2a and 2b schematically depict a configuration according to a first exemplary embodiment with the apron being positioned in a blocking position.

FIGS. 3a and 3b schematically depict a configuration according to the first exemplary embodiment with the apron being positioned in an access position.

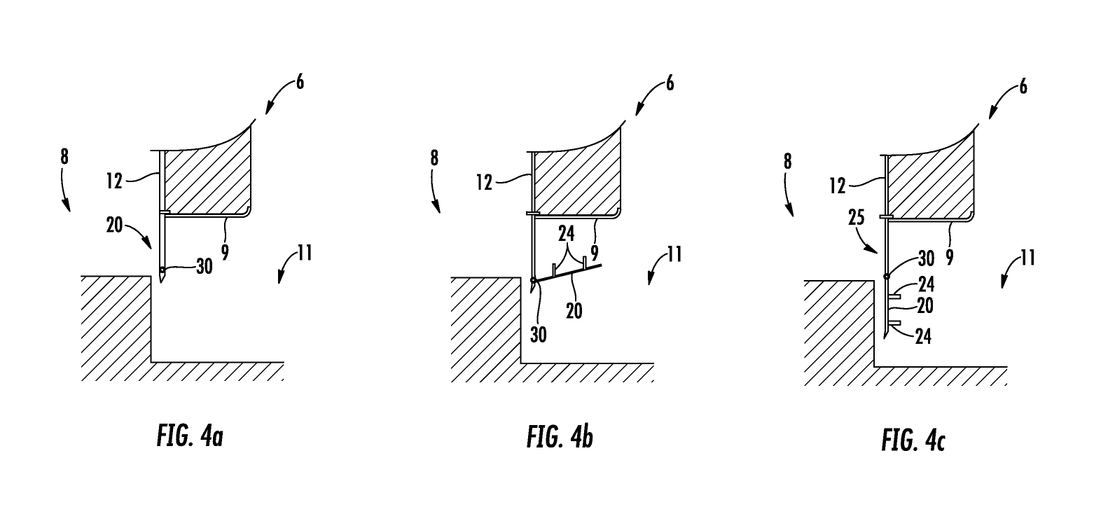

FIG. 4a schematically depicts a second exemplary embodiment with the apron being positioned in a blocking position.

FIG. 4b schematically depicts the second exemplary embodiment with the apron being positioned in an intermediate position.

FIG. 4c depicts schematically depicts the second exemplary embodiment with the apron being positioned in an access position.

FIG. 1 depicts an elevator system 2 according to an exemplary embodiment of the invention.

The elevator system 2 includes an elevator car 6 which is movably suspended within a hoistway 4 by means of at least one tension member 3. The tension member 3, for example a rope or belt, is connected to an elevator drive 5, which is configured for driving the tension member 3 in order to move the elevator car 6 along the height of the hoistway 4 between a plurality of landings 8a, 8b, 8c located on different heights.

Each landing 8a, 8b, 8c is provided with a landing door 10, and the elevator car 6 is provided with a corresponding elevator car door 12 for allowing passengers to transfer between a landing 8a, 8b, 8c and the interior of the elevator car 6 when the elevator car 6 is positioned at the respective landing 8a, 8b, 8c.

The exemplary embodiment shown in FIG. 1 uses a 1:1 roping for suspending the elevator car 6. The skilled person, however, easily understands that the type of the roping is not essential for the invention and that different kinds of roping, e.g. a 2:1 roping, 4:1 roping, etc. are possible as well. The elevator system 2 may use a counterweight (not shown) or not. The elevator drive 5 may be any form of drive used in the art, e.g. a traction drive, a hydraulic drive, or a linear drive. The drive system may use a tension member, like a rope or a belt, or may be a ropeless drive system. The elevator system 2 may have a machine room or may be a machine room-less elevator system.

The elevator drive 5 is controlled by an elevator control unit 7 for moving the elevator car 6 between the different landings 8a, 8b, 8c.

Input to the control unit 7 may be provided via an elevator car control panel 14 provided inside the elevator car 6 and landing control panels 16, which are provided next to the landing doors 10 on each landing 8a, 8b, 8c.

The elevator car control panel 14 and the landing control panels 16 may be connected to the elevator control unit 7 by means of electrical lines, which are not shown in FIG. 1, in particular by an electric bus, or by wireless connections.

Alternatively or additionally, commands may be input into the elevator control unit 7 via mobile devices (not shown), e.g. smartphones, carried by the passengers. In this case, the elevator control unit 7 may be provided with at least one communication unit 17, which is configured for indirectly (including, but not limited to, via the internet or a cellular network) or directly (including, but not limited to via WiFi, Bluetooth, or other known wireless communication methods, such as 1G, 2G (GSM), 3G, 4G (LTE), 5G, and future generations of cellular data communications) wirelessly communicating with the mobile device(s). Additional communication units (not shown) may be provided at the landings 10.

An indicator element 34 is arranged in a lower portion of the hoistway 14. The functionality of said indicator element 34 will be described in more detail further below.

In case the bottom 9 of the elevator car 6 is not positioned exactly at the same level of height as the floor 13a, 13b, 13c of the closest landing 8a, 8b, 8c, a gap is formed between the bottom 9 of the elevator car 6 and the floor 13a, 13b, 13c of the respective landing 8a, 8b, 8c. In order to prevent persons from falling into the hoistway 4 in case the landing door 10 is opened in such a situation, e.g. for releasing passenger which are trapped within the elevator car 6, an apron 20 extends basically vertically from the bottom 9 of the elevator car 6 in an area below the elevator car door 12.

However, there might be situations in which it is desirable to access the hoistway 4 via the landing door(s) 10, e.g. in case the elevator car 6 is positioned in the vicinity of the lowest landing 8a and service personnel needs to enter a pit 11, which is formed at the bottom of the hoistway 4.

According to exemplary embodiments of the invention, the apron 20 is movable from a blocking position, in which the apron 20 blocks the area below the elevator car 6 and does not allow to access the hoistway 4 via the landing door 10, into an access position, in which the apron 20 does not block the area below the elevator car 6, but allows access to the hoistway 4 via the landing door 10.

Exemplary embodiments of the invention are described in more detail with reference to the following figures, respectively depicting an area close to the bottom 9 and below the elevator car 6, in a situation in which the elevator car 6 is close to the lowermost landing 8a, but in a position with some distance above the floor 13a of the landing 8a.

FIGS. 2a and 3a show side-views, while FIGS. 2b and 3b show front views of the area close to the bottom 9 and below the elevator car 6, respectively.

FIGS. 2a and 2b depict a configuration in which the apron 20 is positioned in its blocking position, while FIGS. 3a and 3b depict a configuration in which the apron 20 is positioned in its access position, respectively.

According to the exemplary embodiment shown in FIGS. 2a to 3b, the apron 20 is supported by means of two telescopic extensions 22 located at positions left and right from the center of the elevator car door 12 and extending from the bottom 9 of the elevator car 6 basically vertically parallel to each other. The telescopic extensions 22 are configured to allow moving the apron 20 linearly in a basically vertical direction between the upper blocking position shown in FIGS. 2a and 2b, in which the apron 20 blocks the area below the bottom 9 of the elevator car 6, and the lower access position shown in FIGS. 3a and 3b, in which the apron 20 does not block the area below the bottom 9 of the elevator car 6. When the apron 20 is positioned in said lower access position, an opening 25, which is defined by the bottom 9 of the elevator car 6, the upper edge of the apron 20 and the two vertically extending telescopic extensions 22, is formed. A person may enter the hoistway 4 from the landing 8a via said opening 25.

FIGS. 2a to 3b show further, optional features:

Steps 24 may be formed within the apron 20 or at the side of the apron 20 facing the hoistway 4. Such steps 24 allow a person entering the hoistway 4 to climb down to the bottom of the hoistway 14 (pit 11) easily without using an additional ladder (not shown) or a similar device. The access to such a ladder might be difficult or even impossible when the elevator car 6 is in a position which allows to reach the elements at the bottom of the elevator car when standing in the pit 11.

The steps 24 in particular may be provided as recesses or openings formed within the apron 20. In an alternative configuration, the steps 24 may be provided as webs formed at the side of the apron 20 facing the hoistway 4.

In addition to the steps 24, at least one handrail (not shown) may be provided at the apron 20 allowing a person using the steps 24 to hold on when descending into and/or ascending from the pit 11.

For facilitating the movement of the apron 20 from its access position into its blocking position, at least one handle 26 may be provided at the top of the apron 20 or at the side of the apron 20, in particular at the side of the apron 20 facing the landings 8a, 8b, 8c.

For preventing an undesired movement of the apron 20, an additional blocking mechanism may be provided. In case the apron 20 is supported by telescopic extensions 22, as it is shown in FIGS. 2a to 3b, the blocking mechanism may include bolts or screws 28 extending through corresponding openings formed within the telescopic extensions 22 and thereby blocking any movement of the telescopic extensions 22. The bolts or screws 28 are removed (pulled out) from the openings, in order to allow a desired movement of the apron 20 from its blocking position into its access position. In order to prevent an undesired/accidental removal of the bolts or screws 28, the bolts or screws 28 may be secured within the openings by means of splints (not shown) or similar securing elements.

For preventing an unauthorized release of the blocking mechanism, the blocking mechanism may be provided with an additional locking mechanism. For example, specially formed screws 28, which are releasable only by means of a special tool, may be employed. Alternatively or additionally, at least one lock may be associated with at least one of the bolts or screws 28 such that the respective bolt or screw 28 is removable only after the lock has been unlocked by means of a matching key.

In situations in which the elevator car 6 is positioned at a higher landing 8b, 8c moving the apron 20 out of its blocking position would result in a dangerous situation. The locking mechanism and/or the blocking mechanism therefore may be configured such that they may be unlocked/unblocked only in case the elevator car 6 is positioned within a predetermined distance from the lowest landing 8a. This prevents creating a dangerous situation by moving the apron 20 out of its blocking position while the elevator car 6 is positioned at or close to one of the higher landings 8b, 8c.

Allowing the locking mechanism and/or the blocking mechanism to be unlocked/unblocked only in case the elevator car 6 is positioned within a predetermined distance from the lowest landing 8a may be realized for example by mechanical interaction of the locking mechanism and/or the blocking mechanism with a corresponding indicator element 34 (see FIG. 1), which is arranged in a lower portion of the hoistway 4 for indicating that the apron 20 may be moved into its access position when the elevator car 6 is located next to said indicator element 34 in said lower portion of the hoistway 4.

Additionally or alternatively the locking mechanism and/or the blocking mechanism may comprise electromagnetic elements (not shown) such as solenoids electrically connected with the elevator control unit 7 and configured for releasing the locking mechanism and/or the blocking mechanism (only) in case the elevator car 6 is positioned within a predetermined distance from the lowest landing 8a.

Such electromagnetic elements further may be configured for releasing the locking mechanism and/or the blocking mechanism only after authorized service personnel has been identified by means of a key, a key card, and/or by entering a secret code or similar.

The movable apron 20 may be provided with at least one sensor 32 which is configured for detecting the actual position of the apron 20 and reporting it to the elevator control unit 7. In consequence, the elevator control unit 7 may allow the elevator car 6 to move only in case the apron 20 is detected as being positioned in its blocking position. This enhances the safety of the elevator system 2, as any movement of the elevator 6 is prevented while the apron 20 is not positioned in its blocking position.

FIGS. 4a, 4b, and 4c illustrate a movable apron 20 according to a second embodiment of the invention in its blocking position (FIG. 4a), in its access position (FIG. 4c) and in an intermediate position (FIG. 4b), respectively.

According to said second embodiment, the apron 20 is movable between its blocking position and its access position in a pivoting motion in which the apron 20 rotates around a horizontally extending axle 30 which is provided in some distance below the bottom of the elevator car 6.

When positioned in its blocking position, the apron 20 extends basically vertically upwards from the horizontal axle 30, as it is shown in FIG. 4a.

After being pivoted (FIG. 4b) around the axle 30 into its access position, the apron 20 extends basically vertically downwards from the horizontal axle 30 providing an opening 25 between the axle 30 and the bottom of the elevator car 6 (FIG. 4c). Persons may enter into the hoistway 4 via said opening 25.

The movable apron 20 according to the second embodiment may be provided with appropriate blocking and/or locking mechanisms and/or detecting means which are configured for detecting the actual position of the apron 20, as it has been described with reference to the first embodiment, as well.

The movable apron 20 further may be provided with an appropriate tool (not shown), e.g. with a rope or a rod, which is configured for facilitating the movement of the apron 20 from the access position back into the blocking position.

A number of optional features are set out in the following. These features may be realized in particular embodiments, alone or in combination with any of the other features.

In an embodiment, the elevator car comprises at least one elevator car door and the apron may be arranged below said at least one elevator car door. An apron which is arranged below said at least one elevator car door is very effective in preventing persons exiting from the elevator car via the elevator car door from falling into the hoistway through a gap formed below the bottom of the elevator car.

In an embodiment, the apron may be configured for moving linearly between the blocking position and the access position. A linear motion allows to move the apron between the blocking position and the access position conveniently.

In an embodiment, the elevator car may comprise a telescopic mechanism which is configured for supporting the apron and for moving the apron between the at least two positions. A telescopic mechanism provides a convenient and reliable means for allowing a linear motion of the apron.

In an embodiment, the apron may be configured for moving between the blocking position and the access position in a pivoting motion. This provides a simple alternative to moving the apron linearly between the blocking position and the access position, which may be installed at low costs.

In an embodiment, the elevator car may further comprise a releasable blocking mechanism which allows to prevent the movement of the apron. Such a blocking mechanism enhances the safety of the elevator system, as an undesired and/or accidental movement of the apron out of its blocking position is reliably prevented.

In an embodiment, the elevator car may further comprise a locking mechanism which is configured for preventing an unauthorized release of the releasable blocking mechanism. Such a locking mechanism, which may include a lock, enhances the safety of the elevator system, as any movement of the apron out of its blocking position by unauthorized/unqualified persons is reliably prevented.

In an embodiment, the apron may be movable into the access position only when the elevator car is positioned not more than a predetermined distance spaced apart from the lowest landing. Thus, a method of accessing the hoistway includes moving the elevator car within a predetermined distance from the lowest landing. This enhances the safety of the elevator system, as any movement of the apron is prevented when the elevator car is located next to a higher landing.

In an embodiment, the elevator car is blocked from moving along the hoistway when the apron is not positioned in its blocking position. This enhances the safety of the elevator system even further.

In an embodiment, the movable apron may be provided with at least one sensor which is configured for detecting the actual position of the apron and for reporting it to the elevator control unit. The elevator control unit may be configured to allow the elevator car to move only in case the apron is detected as being positioned in its blocking position. This further enhances the safety of the elevator system.

In an embodiment, at least one step may be formed in or at the apron. Such at least one step facilitates the access to the hoistway when the apron is positioned in its access position. Additionally to the at least one step, a handrail (not shown) may be provided at the apron for allowing a person using the at least one step to hold on for a safe descent into and/or a safe ascent from the pit.

In an embodiment of an elevator system, a pit is formed at the bottom of the hoistway and the apron is movable from its blocking position into its access position for providing access to the pit. This facilitates maintenance and repair of the elevator system.

While the invention has been described with reference to exemplary embodiments, it will be understood by those skilled in the art that various changes may be made and equivalents may be substituted for elements thereof without departing from the scope of the invention. In addition many modifications may be made to adopt a particular situation or material to the teachings of the invention without departing from the essential scope thereof. Therefore, it is intended that the invention not be limited to the particular embodiment disclosed, but that the invention include all embodiments falling within the scope of the claims.

### REFERENCES

2 elevator system
3 tension member
4 hoistway
5 drive
6 elevator car
7 elevator control unit
8a, 8b, 8c landing
9 bottom of the elevator car
10 landing door
11 pit
12 elevator car door
13a, 13b, 13c floor
14 elevator car control panel
16 landing control panel
20 apron
22 extension
24 step
26 handle
28 bolt/screw
30 axle
32 sensor
34 indicator element

1. Elevator car (6) configured for traveling along a hoistway (4) which extends between a plurality of landings (8a, 8b, 8c),
the elevator car (6) comprising an apron (20), which is arranged at a bottom (9) the elevator car (6),
wherein the apron (20) is movable between at least two positions including:
a blocking position in which the apron (20) extends downward from the bottom (9) of the elevator car (6) such as to block access to the hoistway (4) through an area below the elevator car (6); and
an access position, in which the apron (20) is configured for allowing access to the hoistway (4) through the area below the elevator car (6).

2. Elevator car (6) according to claim 1, wherein the elevator car (6) comprises at least one elevator car door (12) and the apron (20) is arranged below said at least one elevator car door (12).

3. Elevator car (6) according to claim 1, wherein the apron (20) is configured for moving linearly between the blocking position and the access position.

4. Elevator car (6) according to claim 3, wherein the elevator car (6) comprises a telescopic mechanism for supporting the apron (20) and for moving the apron (20) between the blocking position and the access position.

5. Elevator car (6) according to claim 1, wherein the apron (20) is configured for moving in a pivoting motion between the blocking position and the access position.

6. Elevator car (6) according to claim 1 further comprising a releasable blocking mechanism (28) which allows to prevent movement of the apron (20), in particular movement from the blocking position into the access position.

7. Elevator car (6) according to claim 6, further comprising a locking mechanism which is configured for preventing an unauthorized release of the releasable blocking mechanism.

8. Elevator car (6) according to claim 1, wherein at least one step (24) is formed in or on the apron (20) for facilitating access to the hoistway (4) when the apron (20) is in the access position.

9. Elevator system comprising:
a hoistway (4) extending between a plurality of landings (8a, 8b, 8c); and
an elevator car (6) according to any of the previous claims.

10. Elevator system according to claim 9, wherein a pit (11) is formed at the bottom of the hoistway (4) and the apron (20) is movable for providing access to the pit (11).

11. Elevator system according to claim 10, wherein the apron (20) is movable into the access position only when the elevator car (6) is positioned not more than a predetermined distance apart from the lowest landing (8a).

12. Elevator system according to claim 10, wherein the elevator car (6) is blocked from moving along the hoistway (4) when the apron (20) is not positioned in the blocking position.

13. Method of accessing the hoistway (4) of an elevator system according to claim 10, wherein the method includes moving the apron (20) of the elevator car (6) from its blocking position to its access position.

14. Method of claim 13, wherein the method further includes releasing a locking and/or a blocking mechanism (30) before moving the apron (20).

15. Method of claim 13, wherein the method further includes moving the elevator car (6) to a position which is not spaced apart more than a predetermined distance from the lowest landing (8a) before moving the apron (20) into the access position.
